(19) United States
(12) Patent Application Publication
(10) Pub. No.: US 2002/0174548 A1
(43) Pub. Date: Nov. 28, 2002

(54) Chopstick

(76) Inventor: Ian Nicholas Monsarratt Day, Southampton (GB)

Correspondence Address: Martin G. Linihan, Hodgson Russ LLP, One M&T Plaza, Suite 2000, Buffalo, NY, 14203-2391, US

(21) Appl. No.: 10/036,954

(22) Filed: Dec. 20, 2001

(30) Foreign Application Priority Data
Dec. 21, 2000 (GB) 0031387.4

(51) Int. Cl. A47J 43/28

(52) U.S. Cl. 30/143; 30/322; 294/1.1; 294/99.2

(57) ABSTRACT

A chopstick having a spike for engaging food. The spike preferably is moveable between an extended position in which it projects beyond the food-engaging end of the chopstick and a retracted position in which it does not substantially so project.

This invention relates to chopsticks.

An inexperienced user of chopsticks can find them difficult to manipulate, possibly spoiling the experience of an otherwise pleasurable oriental meal. Moreover, even experienced users have difficulty in picking-up small pieces of slippery food such as oiled vegetables. The present invention, at least in its preferred embodiments, seeks to provide novel chopsticks which present less of a challenge for the inexperienced user, by offering an alternative means of picking-up items of food.

In one aspect the invention provides a chopstick having a food-engaging end, from which projects a spike for impaling food. Preferably the spike is moveable, so in another aspect the invention provides a chopstick having a moveable spike for engaging food.

The spike may be moveable between an extended position in which it projects beyond the food-engaging end of the chopstick and a retracted position in which it does not substantially so project.

The chopstick may have a hollow body portion wherein the spike is disposed.

Preferably the spike is at one end of an elongated rod disposed in the body portion.

There may be means external of the chopstick for moving the spike between its retracted and extended positions.

Thus the body portion may have a bore with two ends, the elongated rod being disposed in the bore so that the spike can be extended through one end thereof, the other end of the rod projecting from the other end of the bore whereby a user may push the rod to extend the spike.

The bore may be continuous throughout the length of the chopstick.

In a second aspect the invention provides a chopstick having a longitudinal bore so that it may be used as a drinking straw.

The bore may increase in diameter from the food-engaging end of the chopstick to the other end.

Preferably there are means for securing the spike in its extended position.

Thus one of the elongated rod and the body portion may have a detent which engages a recess in the other. Alternatively the rod may frictionally engage the bore by being a tight fit therein.

Alternatively the elongated rod may be naturally curved and be maintained in an elastically deformed state when disposed in the body portion. The elastic deformation causes the rod to bear against the side of the bore and thereby increase its frictional engagement therewith.

At least the body portion of the chopstick may be disposable.

The invention also provides the use of a chopstick having a spike at a food engaging end thereof to impale items of food. A further aspect of the invention provides the use of a chopstick having a bore therethrough as a drinking straw.

The invention will now be described merely by way of example with reference to the accompanying drawings, wherein:

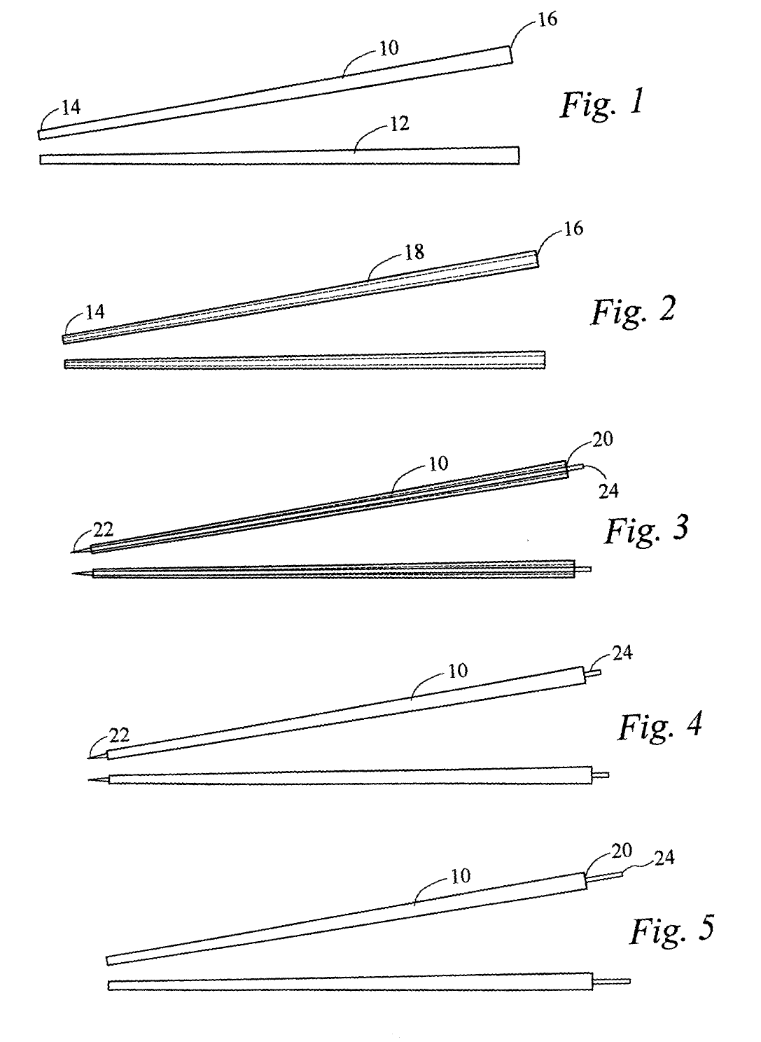

FIG. 1 shows conventional chopsticks;

FIG. 2 shows chopsticks according to one aspect of the invention,

FIGS. 3, 4 and 5 show chopsticks according to another aspect of the invention; and

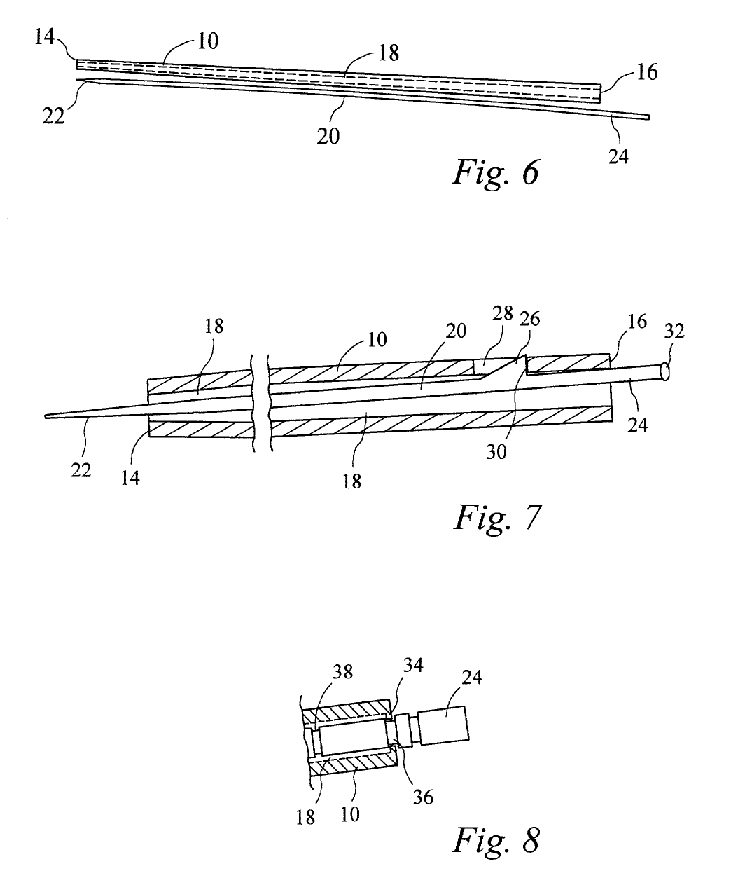

FIGS. 6, 7 and 8 illustrate further embodiments of the invention, FIGS. 7 and 8 being in section.

Referring to FIG. 1, as is well known, conventional chopsticks 10, 12 are made from bamboo, another wood, or a food-grade plastics material such as a polyamide. The chopsticks, typically about 20 cm long, are either square section at one end, tapering to a round section at the other end (Chinese style) or of square section throughout, but tapering significantly from one end 14 to the other 16 (Japanese style). In both cases the smaller end is the food-engaging end. Although the end 14 is smaller than the end 16 it is still blunt (non-pointed) so as to provide adequate surface area (when used with the other chopstick of the pair) to provide a spatulate surface for picking up particulate food such as rice.

Referring to FIG. 2, in this embodiment of the present invention, a longitudinal bore 18 (FIG. 2) is provided through the length of each of the chopsticks. The bore preferably tapers towards the food-engaging end 14.

An elongated rod-like skewer 20 (FIG. 3) is slidably disposed in the bore of each of the chopsticks. The skewer is of bamboo, other wood, food-grade plastics or stainless steel. It has a pointed end or spike 22, and a blunt end 24. Its length is rather greater than that of the chopstick, so that the spike 22 projects from the food-engaging end 14 and the other end 24 of the rod projects from the end 16 of the chopstick. By moving the skewer 20 within the bore of the chopstick body the spike 22 can be either retracted within the body (FIG. 5) or extended from it (FIG. 4). Extending the spike is achieved by pushing the end 24 of the rod 20. Retracting it is achieved either by pulling the rod 20 or (with care to avoid damaging the spike) pushing the body portion forward with the spike against a firm surface.

When the spikes are retracted, the chopsticks can be used in the conventional manner. When the spike is extended the chopsticks can be used to impale or skewer pieces of food; for this purpose one chopstick can be used on its own, If both chopsticks of the pair are used with their spikes extended they can be used effectively as a fork, or alternatively the extended spikes permit individual items of food to be picked up in the traditional manner with great precision.

The elongated skewer 20 is shaped such that it engages fictionally with the sides of the bore 18 of the chopstick body when the spike is extended and holds the spike in its extended position sufficiently firmly for food to be impaled without the spike being pushed back into the bore 18.

The frictional engagement can be achieved by providing the skewer 20 with a taper which conforms to that of the bore 18. Alternatively when the skewer and/or the chopstick body is of bamboo or another absorbent wood, the tendency of these materials to swell when wet will be sufficient to ensure firm location of the skewer in the bore, provided the relative dimensions are chosen with care.

In another embodiment, the skewer rod 20 is of an elastically deformable (springy) material (here bamboo) and is formed so as to have a slight curvature, as shown in FIG. 6. Thus, when the skewer 20 is inserted in the bore 18 it is bent and its resilience causes it to bear against the sides of the bore, thereby holding it in place sufficiently firmly for its food-impaling function. The chopstick body 10 in FIG. 6 also is of bamboo, and exhibits little if any longitudinal taper.

A further embodiment as shown in FIG. 7. This embodiment is particularly suited for large-scale industrial manufacture because it embodies positive location of the skewer 20 in its extended-spike position and does not rely on frictional engagement between the skewer end and the bore of the chopstick, which may vary unacceptably depending on the conditions of use.

In the FIG. 7 embodiment, the skewer 20 is provided near its end 24 with a tooth or detent 26 (shown exaggerated in size for clarity) which is shaped to enter into a slot 28 in the wall of the chopstick body 10 when the spike 22 is extended. The detent 26 has a bluff (preferably slightly reentrant) surface 30, which engages the end of the slot 28 to fix the spike in its extended position. The skewer 20 is slightly curved so that it is flexed when in the bore 18, in a direction such that the detent is biased into the slot 28.

The bore 18 of the chopstick is tapered as previously described. At the end 16 of the chopstick body it is sufficiently larger than the diameter of the skewer 20 for it to be possible to disengage the detent 26 from the slot 28 by moving the end 24 of the skewer sideways within the bore. The spike 22 then can be retracted. FIG. 7 also illustrates that the end 24 of the skewer can conveniently be provided with a pad or button 32 for ease of use.

FIG. 8 shows the holding (non-food-engaging) end of another form of chopstick according to the invention, being an alternative to that of FIG. 7. Here the end 16 of the body portion has an inwardly projecting lip 34 around the end of the bore l. One or more recesses in the form of grooves 36 are provided in the end of the rod 24. The lip acts as a detent which engages the groove 36 to locate the spike 22 in its extended position. A further groove 38 may be provided inwardly of the groove(s) 36 to lock the spike in its retracted position The inside diameter of the lip 34 and the outside diameter of the rod 20 are such that the rod is fixed in the bore for normal food-impaling use of the spike, but greater applied force will cause the lip to deform and ride over the rod so that the spike can be extended or retracted. Alternatively, as in FIG. 7, the rod 20 maybe resilient and slightly curved so that the deformation of the rod holds the lip 34 and groove 36 or 38 in engagement with each other. The bore then is sufficiently larger in diameter than the rod so that the lip and groove may be disengaged by moving the rod sideways as described with reference to FIG. 7.

In a mass manufactured product the skewer should be of a plastics material hard enough to maintain a sharp point, whilst exhibiting resilience in bending. A polyamide or other material customarily used for plastics cutlery would be suitable. Alternatively, if the skewer is intended to be washed and re-used, it could be of stainless steel Generally, for restaurant use the chopstick and its skewer would be of plastics material and used only once, but in a domestic environment it is possible with careful washing to re-use both the skewer and the body.

The hollow body of the chopstick also lends itself to use as a drinking straw eg. for soups when the skewer is removed. In the FIG. 7 embodiment the slot should then be covered by the user's finger, to maintain the necessary vacuum.

Another function of the chopstick is as a syringe for drawing up a small quantity of sauce or other liquid eg. from a communal bowl for transfer to the user's plate. To achieve this the skewer rod 20 is made a close fit in the bore, so that it will act as a piston. The food-engaging end of the chopstick is dipped into the liquid to be transferred, and the skewer rod is withdrawn up the bore, thereby creating a vacuum to draw the liquid into the bore. The trapped liquid then is transferred, and is subsequently expelled by pushing the skewer rod back down the bore.

A number of variations on the basic principle of the invention are possible. Thus instead of the bore extending the full length of the chopstick it can be taken out sideways part-way along the length, the end of a shorter (but still relatively elongated) skewer rod projecting therefrom for movement by the user's thumb whilst still holding the chopsticks in their operative position. Also, whilst it is preferred that both chopsticks of a pair are provided with retractable spikes, if desired one chopstick may be according to the invention and the other one may be conventional.

In a simplified form the chopstick may be provided with a fixed relatively short point or spike projecting from its food-engaging end. Such a spike would have the same appearance as spike 22 in FIG. 4. By being relatively short, the spike permits the adjacent end of the chopstick still to be used in the conventional way.

Each feature disclosed in this specification (which term includes the claims) and/or shown in the drawings may be incorporated in the invention independently of other disclosed and/or illustrated features.

Statements in this specification of the “objects of the invention” relate to preferred embodiments of the invention, but not necessarily to all embodiments of the invention falling within the claims.

1. A chopstick having a moveable spike for engaging food.

2. A chopstick having a food-engaging end, from which projects a moveable spike for impaling food.

3. A chopstick as claimed in claim 2 wherein the spike is moveable between an extended position in which it projects beyond the food-engaging end of the chopstick and a retracted position in which it does not substantially so project.

4. A chopstick as claimed in claim 2 wherein the chopstick has a hollow body portion wherein the spike is disposed.

5. A chopstick as claimed in claim 4 wherein the spike is at one end of an elongated rod disposed in the body portion.

6. A chopstick as claimed in claim 3 comprising means external of the chopstick for moving the spike between its retracted and extended positions.

7. A chopstick as claimed in claim 6 wherein the body portion has a bore with two ends, an elongated rod being disposed in the bore, the spike being at one end of the rod so that the spike can be extended through one end of the bore, the other end of the rod projecting from the other end of the bore whereby a user may push the rod to extend the spike.

8. A chopstick as claimed in claim 7 wherein the bore is continuous throughout the length of the chopstick.

9. A chopstick as claimed in claim 1 having a longitudinal bore so that it may be used as a drinking straw.

10. A chopstick as claimed in claim 9 wherein the bore increases in diameter from the food-engaging end of the chopstick to the other end.

11. A chopstick as claimed in claim 3 thereon comprising means for maintaining the spike in its extended position.

12. A chopstick as claimed in claim 11 wherein the spike is maintained in its extended position by friction.

13. A chopstick as claimed in claim 5 wherein the elongated rod is curved so as to engage the hollow body portion and maintain the spike in its extended position.

14. A chopstick as claimed in claim 5 wherein one of the elongated rod and the body portion has a detent which engages a recess in the other.

15. A chopstick as claimed in claim 14 wherein the elongated rod is naturally curved and is maintained in an elastically deformed state when disposed in the body portion.

16. A chopstick as claimed in claim 4 wherein the body portion and/or the spike are disposable.

17. A chopstick as claimed in claim 1, when presented as disposable after a single use.

18. The use of a chopstick as claimed in claim 1 to impale items of food.

19. The use of a chopstick as claimed in claim 18, the chopstick having a bore therethrough and being used also as a drinking straw.

20. A pair of chopsticks, at least one of which is as claimed in claim 1.
